(19) United States
(12) Patent Application Publication
(10) Pub. No.: US 2020/0407166 A1
(43) Pub. Date: Dec. 31, 2020

(54) PICKING DEVICE WITH AN IMAGE VIRTUALLY LOCATED IN A WORK AREA

(71) Applicant: Kardex Produktion Deutschland GmbH, Neuburg/Kammel (DE)

(72) Inventors: Volker Jungbluth, Dortmund (DE); Wolfgang Kollmann, Pfaffenhausen (DE); Florian Schrot, Neu-Ulm (DE)

(21) Appl. No.: 16/977,120

(22) PCT Filed: Jan. 30, 2019
(86) PCT No.: PCT/EP2019/052176

§ 371 Date: Sep. 1, 2020

(30) Foreign Application Priority Data
Mar. 2, 2018 (DE) 10 2018 203 175.4

(51) Int. Cl. B65G 1/137

(52) U.S. Cl. CPC B65G 1/1378; G03B 21/2006

(57) ABSTRACT

The invention refers to a picking device (1) for picking articles, in particular for a storage lift (3), with at least one operating area (5) for an operator (7), with at least one work area (9) for picking, and with at least one projection device (15) for at least temporarily marking a location (17) at least in the work area (9). The invention also refers to a method for picking. In order to improve the ergonomics for the operator and the efficiency of picking, it is provided according to the invention that the picking device (1) has, during operation, at least one image (19) which can be viewed from the operating area (5) and is virtually located in the work area (9).

The invention refers to a picking device for picking articles, in particular for an automatic storage system such as a storage lift, with at least one operating area for an operator, with at least one work area for picking, and with at least one projection device for at least temporarily marking a location at least in the work area. The invention also refers to a method for picking articles, in particular for a storage lift.

Picking devices and methods for picking articles are well known. Typically, at least one operator stays in an operating area or common area and has access to a work area from there. The work area can be, for example, an opening in a storage lift or an accessible place on a conveyor track. There the operator can remove articles from the device, in particular from trays or other containers, and/or feed them to the device for storage. A picking device may in particular be an automatic storage system, a storage lift, a paternoster store, a picking trolley, a system of conveyor tracks, a non-continuous conveyor, or any other suitable system.

When picking, it can be helpful if the operator knows, for example, before the arrival of an article, where in the work area the article will arrive and/or which articles it is. For storage it can be helpful to know where the article will be placed before it is stored. For this purpose, known devices have a projection device which illuminates a section of the work area in order to signal that at least one article is to be deposited or stored in this section and/or an article is to be removed or retrieved from this section.

It is the object of the invention to provide a picking device and method of the above mentioned type, which further improves the ergonomics for the operator and thereby simplifies picking. By simplifying the picking process, picking efficiency can be increased and the number of incorrect storages or removals can be reduced.

For the picking device mentioned above, the object according to the invention is solved by the fact that the picking device has, during operation, at least one image which can be seen from the operating area and is virtually located in the work area. For the method mentioned above, the object according to the invention is solved in that, according to the method, articles are removed from and/or stored at at least one work area, at least one location in the work area being marked with at least one image which can be viewed from at least one operating area and is virtually located in the work area.

The image virtually located in the work area, colloquially known as a 3D projection or “hologram”, can make picking more intuitive than simply illuminating a location. This can simplify picking. The image is generated by the at least one projection device. It can be a so-called floating image, which seems to float in space, i.e. virtually. The image can be a spatial representation, whereby the spatial impression—depending on the projection device used—can only be created by the viewer himself. Especially in such a case, the image can only be seen from the operating area.

The image can indicate where the next article to be picked is expected to be. The motif of the image can also give an indication of the type of article to be picked. This simplifies operation and improves ergonomics for the operator. The displayed image and its location may depend on the order data of the picking device.

The solution according to the invention can be further improved by various designs, each of which is advantageous in itself and can be combined with each other in any way. These forms of design and the advantages associated with them are described in the following. The method according to the invention can be carried out with the described designs of the picking device according to the invention. In other words, the advantages described with respect to the picking device according to the invention also apply to the operation of a picking device by means of the method according to the invention. Likewise, the advantages described with respect to the method can be transferred to the picking device according to the invention.

According to a first advantageous design, the at least one projection device can be connected to at least one storage element containing an image database. The image database may in particular be an article image database. The image database may contain images, in particular three-dimensional images, of articles. This may make it possible to generate an image of the article by the projection device. Picking can be simplified by this intuitively understandable display of the article to be picked in the work area.

Preferably, the database contains images of all articles to be picked. These can be either schematic example images or photorealistic representations of the articles. It is also possible to provide example images or schematic representations at least for those articles for which no detailed images are available.

To further simplify picking, the at least one projection device may be connected to at least one storage element containing an order database, in particular a picking database. The order database may contain, for example, the number of articles to be picked. Thus, the image can display, in addition or alternatively to the object image, the number of articles to be picked or stored.

The storage element containing the order database can be identical to the storage element containing the image database. Alternatively, the storage elements, separately or together, can be parts of a control system of the picking device. According to another alternative, the order database can be part of a storage element which is, for example, part of a computer connected to the picking device and/or the projection device via appropriate interfaces. This also applies to the storage element containing the image database.

According to another advantageous design, the at least one projection device can be connected to at least one control unit which is designed to calculate the arrival time of an article. In this way it may be possible to display in the image a remaining time until the arrival of the article. This display may be dynamic. In other words, the image can display a countdown until the arrival of the article. The remaining time and/or the arrival time can be displayed alternatively or in addition to an image of the article.

Preferably, the at least one projection device is captively connected to a fixed part of the picking device. The projection device can therefore do without additional devices that have to be carried by the operator. In particular, special aids such as stereoscopic glasses or glasses for displaying so-called “augmented reality” or those for displaying “virtual reality” can be dispensed with. Such glasses are often bulky and/or restrict the operator's field of vision. They also have a low wearing comfort.

In order not to obstruct the picking of articles by the at least one projection device, the at least one projection device can be located above the at least one work area. The at least one work area may in particular be a work surface, a container carrier, a table, a shelf, or a section of a conveyor track. It is also possible that the at least one work area is accessible through at least one service opening, for example a service opening of a storage lift.

The generation of at least one virtual image in the work area can be achieved by various technical measures. Only as an example the possibility is mentioned here that the at least one projection device comprises at least one generator for a light-generating plasma. This generator can act on air molecules in the work area, or in the air above the work area, in such a way that a light-generating plasma is created. In this way, luminous images can be produced. For example, the generator can emit laser beams that can put air molecules into a plasma state.

As an alternative or in addition to the technical implementation mentioned above, the at least one projection device may include at least one autostereoscopic projector. By means of autostereoscopic projection it is possible to create a spatial impression for the operator in the operating area if the operator's view is directed towards the work area. This makes additional aids such as stereoscopic glasses unnecessary.

Depending on the method used, it may be necessary for the picking device to have a transparent or semi-transparent disk, which is located between the operating area, in particular a section of the operating area where the operator's eyes are expected to be located, and the work area. Such a disk can be positioned in such a way that access to the work area by the operator's hands is still possible. In particular, the said disks may be equipped with beam splitters or other optically effective structures which may be necessary for autostereoscopic projection.

Preferably the picking equipment is an automatic storage system, a storage lift, a paternoster store, a system of conveyor tracks or a non-continuous conveyor.

The picking device may be provided with at least two horizontally spaced projection devices, at least one conveyor track connected to the picking device running between the at least two projection devices. The at least one conveyor track may lead to or from the picking device. The conveyor track may be part of the picking device. However, it can also be part of a storage system comprising the picking device. A system consisting of two projection devices can be useful, for example, if each projection device generates an image for one eye of the operator. This type of technology can, of course, also be used for picking devices that do not have conveyor tracks. For example, two projection devices can be located at horizontally spaced positions above a work area of a storage lift.

As already described above, at least one projection device can preferably generate an image whose location depends on the respective picking order. In other words, an image can be generated at different locations in the work area. The at least one projection device is therefore preferably equipped with means to adjust the position of the generated image. Such means can be, for example, electric motors or other active elements which can specifically align the projection device. Alternatively or additionally, deflection devices may be provided which deflect the light emitted by the at least one projection device. In this case the deflection devices may be movable.

At least one projection device that is designed to produce images at different locations can also be used to produce an image that moves with a part of the picking device. For example, if a location in a storage good carrier or a tray is to be marked, the image can be generated in or above the storage good carrier while it is still moving. For example, while a storage good carrier is moved into a service opening in a storage lift, an image can be generated at the point where the storage good is to be removed or inserted.

The picking device is preferably provided with a detection device which is designed to detect at least part of an operator. It may, for example, be advantageous to detect the position and orientation of the operator's eyes in order to adjust the image generated or the projection device for generating the image accordingly. This can improve the quality of the image.

In addition, it may be possible to use at least one detection device to detect the position of at least one hand of the operator. In this way it may be possible to recognize gestures of the operator, for example to control the picking device. It is particularly advantageous if the operator can interact with the at least one image. For example, a virtual touch of the image, whereby the operator moves at least one hand to the position where the image is virtually displayed, can be recognized as confirmation of a successful operator action, such as removal or placing goods in storage.

According to another advantageous design, the picking device can also have at least one generator by which a tactile stimulus can be generated. For example, ultrasonic generators are known to be able to generate a tactile stimulus at any point in space. This point is preferably in the area of the generated image. In other words, the operator can touch the image and feels a stimulus on his hands. This can make interaction with the image, as described above, more intuitive. For example, virtual control buttons can be displayed whose touch gives the impression that a real control button has been pressed.

It is also possible to assign further hand or head movements of the operator to specific control functions. For example, stopping the picking device can be triggered by a corresponding movement detected by the detection device.

Alternatively, the confirmation of an operator action can also be detected in the conventional way, for example by pressing a button or by input on an input device such as a keyboard or touch screen.

No matter how an operator action is confirmed, the displayed image can be changed in response to the confirmed operator action. For example, the picking device can respond to the operator's confirmation. Just as an example, the image may show an intuitively understandable object, for example a green hook, a thumb pointing upwards or a crossed out image of the article.

In the event that articles which are removed from the picking device are to be processed in a further step, this can also be simplified by the picking device according to the invention. For example, the projection device can display the work steps to be completed. If, for example, two articles are to be put together, this can be displayed by the projection device to instruct the operator accordingly.

The picking device according to the invention can also be mobile. A preferred movable picking device is a picking trolley which is movable on rollers. Instead of a picking trolley, the picking device can also be another transport system, for example a lift truck. For example, the mobile picking device can have shelf levels in which at least one work area is located. Preferably the at least one projection device is arranged above the shelf levels so that at least one image can be generated which is virtually arranged in the at least one work area.

In the following, the invention is explained in more detail by means of advantageous embodiments with reference to the drawings. The combinations of features shown in the embodiments can be supplemented by further features for a specific application in accordance with the above explanations. Also, in accordance with the above explanations, individual features can be omitted from the described embodiments if the effect of these features in a specific application is not important.

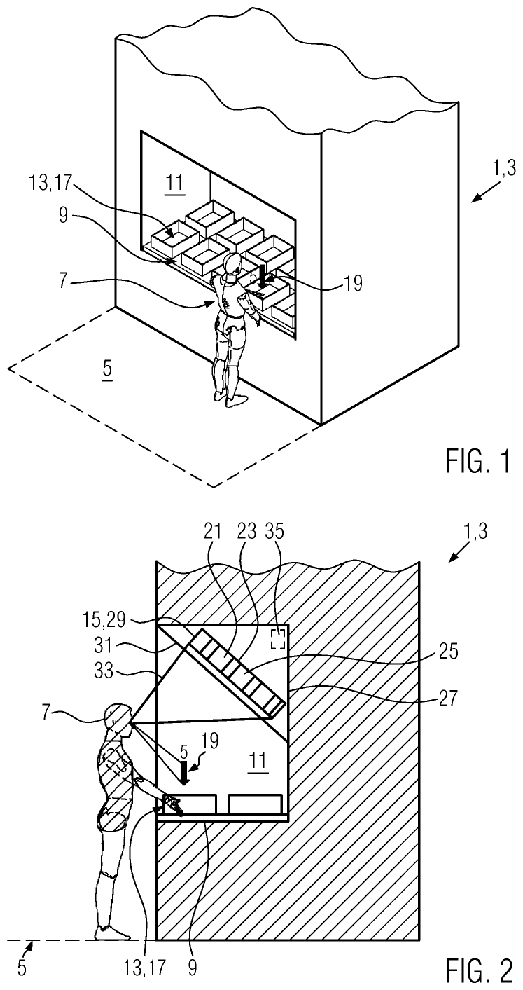

FIG. 1 shows a storage lift as a picking device according to the invention in a perspective view;

FIG. 2 shows the storage lift of FIG. 1 in a sectional view;

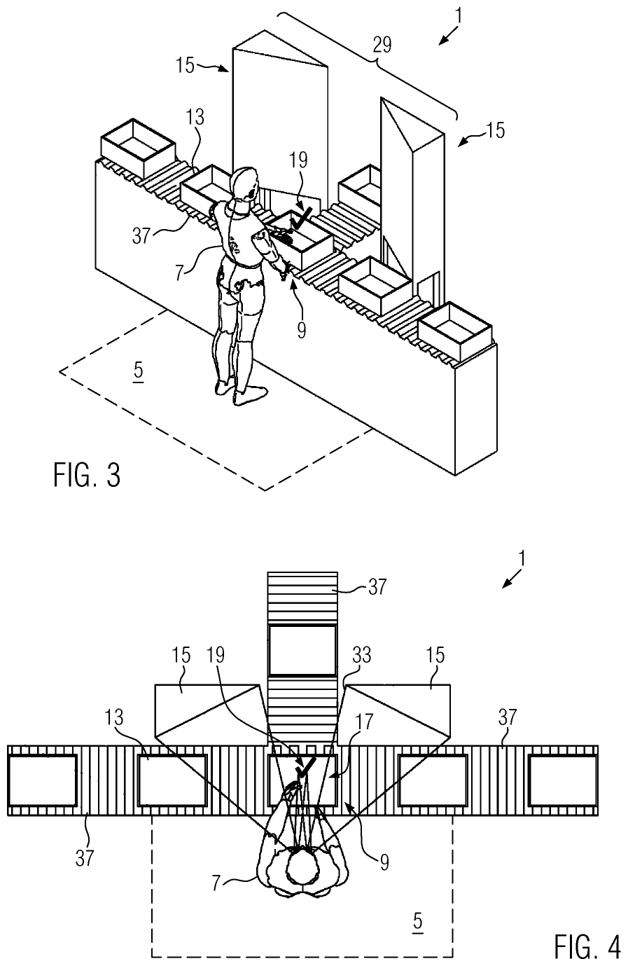

FIG. 3 shows a picking device according to the invention with a conveyor track in a perspective view;

FIG. 4 shows the picking device from FIG. 3 in a top view;

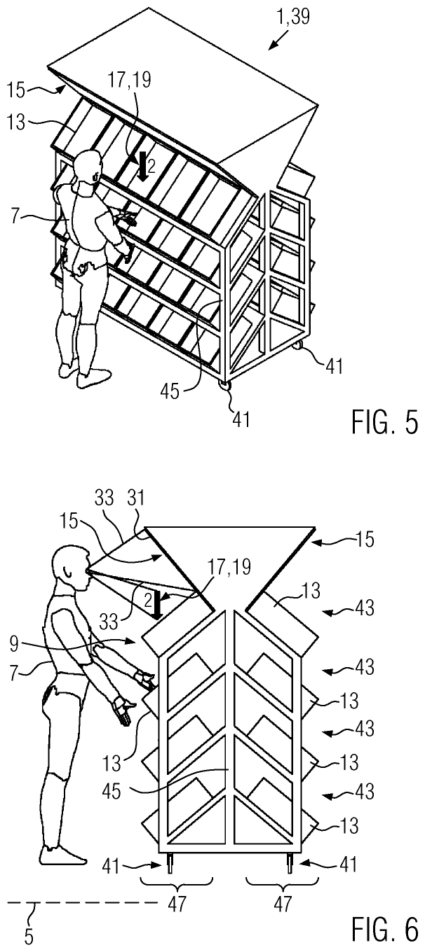

FIG. 5 shows a picking trolley as a further embodiment of the picking device according to the invention in a perspective view; and

FIG. 6 shows the picking trolley from FIG. 5 in a sectional view.

In the following, a first advantageous embodiment of a picking device 1 according to the invention is described with reference to FIGS. 1 and 2. For the sake of brevity, only the differences to the first embodiment are mentioned in the description of the other embodiments with reference to FIGS. 3 to 6.

The picking device 1 is used to pick articles (not shown). The first embodiment of the picking device 1 is a storage lift 3. The picking device has an operating area 5 for an operator 7. In the Figures, the operating area 5 is only indicated by dashed lines. The picking device 1 also has a work area 9. The operator 7 preferably has access to the work area 9 from the operating area 5. The operator 7 also preferably has an unobstructed view of the work area 9 from the operating area 5. The work area 9 can be used for picking articles. This means that in the work area 9, articles can be delivered for removal by the picking device 1, or they can be fed to picking device 1 for storage.

In the storage lift 3 the work area 9 is part of the service opening 11 or accessible through the service opening 11. The work area 9 can be delimited by a work surface, a table or a container carrier.

In the picking device 1, storage goods containers 13 can be used to hold articles. The storage goods containers 13 can be moved by picking device 1. In this case, the storage goods containers 13 can be moved directly by the picking device 1 or together with storage good carriers or similar devices. However, the use of storage goods containers 13 is only shown here as an example and is not mandatory.

The picking device 1 is equipped with a projection device 15. The projection device 15 can be used to mark a location 17 at least in the work area 9. The location 17 can be the place where an article to be picked is located or where an article is to be deposited.

Preferably, the location 17 coincides with one of the storage goods containers 13. However, the location 17 can also be a location or section of the work area 9. Alternatively, the location 17 can also be only a section of a storage goods container 13.

To mark the location 17, the picking device 1 has at least one image 19, which can be viewed from the operating area 5 and is virtually located in the work area 9. Preferably the at least one image 19 is virtually located at the location 17.

As an example for an image 19, FIG. 1 shows an arrow which virtually floats above the location 17 or the storage food container 13. Image 19 also shows a number which represents, for example, the number of articles to be removed. As an alternative to the arrow, which is only mentioned as an example, any other meaningful representation can be chosen. Only exemplary are mentioned here: A photo of the article to be removed, a three-dimensional image of the article, a symbol image matching the article or the insertion of text.

In order to display corresponding images 19, the at least one projection device 15 may be connected to at least one storage element 21 containing an image database. Such a storage element 21 is indicated in FIG. 2. The at least one storage element 21 may be part of the picking device 1, part of the projection device 15 or an external control device. The control device (not shown) may be a personal computer.

In order to display further information, for example the number of articles to be removed, in image 19, the at least one projection device 15 can be connected to at least one storage element 23, which contains at least one order database. The storage element 23 is indicated in FIG. 2. Like the storage element 21, the storage element 23 can be part of the picking device or part of the projection device 15. Alternatively, it can also be part of an external control device.

The at least one projection device 15 can also be connected to at least one control unit 25, which is designed to calculate an arrival time of an article in the work area 9. In this way the at least one projection device 15 can display the time remaining until the arrival of an article, i.e. a countdown.

The at least one projection device 15 is preferably captively connected to at least one stationary part 27 of the picking device 1. Such a stationary part 27 can be, for example, a frame (not shown) of picking device 1.

In addition, the stationary part 27 can also be a housing of picking device 1. It is also possible that the at least one projection device 15 is held independently of picking device 1. For example, the at least one projection device 15 may be supported by a rack or held by a suspension device. It is advantageous in this case if the at least one projection device 15 is held immovably relative to order picking device 1.

To produce the image 19, the at least one projection device 15 may include, for example, an autostereoscopic projector 29. The autostereoscopic projector 29 can produce an image 19 with a spatial impression without the need for stereoscopic glasses, for example. In particular, where the projection device 15 includes an autostereoscopic projector 29, an additional disk 31 may be placed between the projector 29 and work area 5.

For example, the disk 31 may have beam splitters that split images generated by the projector 29 between the two eyes of operator 7. In autostereoscopic projection, light 33 is directed directly onto the field of view of the operator 7 or onto his eyes. In the case of the operator 7, the separate provision of image information for each eye creates the impression that the image 19 is located in the work area 9. From the viewpoint of operator 7, the image 19 is preferably located above location 17.

As an alternative to autostereoscopic projection, a generator 35 can be used instead of projector 29. The generator 35 is shown in FIG. 2 only as a dashed line. The generator 35 can generate a light-generating plasma. For example, the generator 35 can direct laser beams to where an image 19 is to be created. The laser radiation can bring air molecules into a plasma state so that they emit light in the visible range. In this way, a luminous image 19 can be generated in the work area 9.

In the following, a second advantageous embodiment of a picking device 1 according to the invention is described with reference to FIGS. 3 and 4. For the sake of brevity, only the differences to the embodiment described with reference to FIGS. 1 and 2 have been mentioned.

The picking device 1 has conveyor tracks 37, which are only exemplary T-shaped. The picking device 1 of the second type is essentially formed by the work area 9, which can be a sorting station.

Conveyor tracks 37 can be part of the picking device 1. In this case, or also in the case that the conveyor tracks 37 are not part of picking device 1, they are at least connected to the picking device 1 in order to transport the storage goods containers 13 to or from the work area 9 via conveyor tracks 37. The conveyor tracks 37 can also be used to transport other objects. Only examples of this are storage goods without containers, storage goods trays or storage goods carriers of any suitable shape.

One of the conveyor tracks 37 extends away from the work area 9, while two other conveyor tracks 37 run at right angles to the first mentioned conveyor track 37. One of the conveyor tracks 37 extends between two horizontally spaced projection devices 15. The projection devices 15 may cooperate to allow each projection device 15 to emit light to one of the eyes of the operator 7. This arrangement makes it possible, for example, to dispense with an additionally mounted disk 31 with beam splitters.

Preferably, the work area 9 is at a height that is essentially between the two projection devices 15. This has the advantage that when the operator 7 is near the work area 9, he is positioned centrally between the two projection devices 15 and thus maintains a substantially equal distance to both projection devices 15. This ensures the quality of the spatial representation.

The two projection devices 15 together form an autostereoscopic projector 29. The image 19, which is generated by the projector and perceived by the operator 7, is located in the work area 9 and marks a location 17. The image 19 can, for example, mark one of the storage goods containers 13. Alternatively or additionally it can also mark a location 17 within the storage goods container 13. It is also possible that the image 19 moves at least a little bit with a storage goods container when it is moved along one of the conveyor tracks 37.

The system consisting of two projection devices 15 can also be used for the picking device 1 of the first embodiment, which is designed as storage lift 3.

In the following, a third embodiment of the picking device 1 according to the invention is discussed with reference to FIGS. 5 and 6.

The third embodiment of the picking device 1 according to the invention is a picking trolley 39, which is movable on rollers 41. Instead of a picking trolley 39, the picking device 1 can also be another movable transport system, for example a lift truck.

The picking trolley 39 has a plurality of shelf levels 43 in which storage goods containers 13 can be picked. The picking trolley 39 is equipped with a rack 45 for this purpose. The rack can hold the storage goods containers 13 and is connected to the rollers 41. The rack 45 forms the stationary part 27 of picking trolley 39.

A projection device 15 is arranged above shelf level 43. The projection device 15 is preferably fixed to the rack 45. In this case, a disk 31 with beam splitters extends between the rest of the projector 29 and the work area 9 in such a way that the light generated by the projector 29 can reach the eyes of the operator 7. Alternatively, a plurality of projectors 15 can be arranged so that each projector emits 15 light 33 to one eye of the operator 7.

The picking trolley 39 with two horizontally opposite rows 47 of shelf levels 43 is only shown as an example. Preferably the picking trolley 39 has at least one projection device 15 for each of the rows 47.

It is also preferable that the at least one projection device 15 is designed to generate an image 19 at the height of each of the shelf levels 43. Alternatively, each level 43 may also be provided with at least one projection device 15 which is designed to generate images 19 in the respective underlying level 43 or in a plurality of the levels 43.

Preferably the projection device 15 of the third embodiment is battery operated, so that the trolley 39 can be moved and used without connection to a power supply.

### REFERENCE NUMERALS

1 picking device

3 storage lift

5 operating area

7 operator

9 work area

11 service opening

13 storage goods container

15 projection device

17 location

19 image

21 storage element

23 storage element

25 control unit

27 stationary part

29 autostereoscopic projector

31 disk

33 light

35 generator

37 conveyor track

39 picking trolley

41 roller

43 shelf level

45 rack

45 row

1. A picking device for picking articles for an automatic storage system, comprising:
at least one operating area for an operator;
at least one work area for picking; and
at least one projection device for at least temporarily marking a location (17) in the at least one work area, wherein the picking device has, during operation, at least one image which can be viewed from the operating area and is located virtually in the work area.

2. The picking device of claim 1, wherein the at least one projection device is connected to at least one storage element containing an image database.

3. The picking device of claim 1, wherein, the at least one projection device is connected to at least one storage element containing an order database.

4. The picking device of claim 1, wherein the at least one projection device is connected to at least one control unit which is adapted to calculate the arrival time of an article.

5. The picking device of claim 1, wherein the at least one projection device is captively fixedly connected to a stationary part of the picking device.

6. The picking device of claim 1, wherein the at least one projection device comprises at least one generator for a light-generating plasma.

7. The picking device of claim 1, wherein the at least one projection device comprises at least one autostereoscopic projector.

8. The picking device of claim 1, wherein the at least one projection device is arranged above the at least one work area.

9. The picking device of claim 1, wherein the picking device is an automatic storage, a storage lift, a paternoster storage, a non-continuous conveyor, a picking trolley or a system of conveyor tracks.

10. The picking device of claim 1, wherein the picking device is provided with at least two projection devices spaced apart horizontally from one another, at least one conveyor track connected to the picking device running between the at least two projection devices.

11. A method for picking articles for a storage lift including at least one work area from which articles are removed and/or into which articles are stored, comprising:
marking at least one location in the work area is marked with at least one image which is visible from at least one operating area and is virtually located in the work area.

12. (canceled)

13. The picking device of claim 10, wherein each of the at least two projection devices is configured for generating an image for one eye of the operator.
